(19) United States
(12) Patent Application Publication
(10) Pub. No.: US 2010/0283826 A1
(43) Pub. Date: Nov. 11, 2010

(54) AUDIOVISUAL TERMINAL

(76) Inventor: Michael Andrew Henshaw, Cheshire (GB)

Correspondence Address: NOTARO, MICHALOS & ZACCARIA P.C., 100 DUTCH HILL ROAD, ORANGEBURG, NY, 10962, US

(21) Appl. No.: 12/675,861

(22) PCT Filed: Sep. 1, 2008
(86) PCT No.: PCT/GB08/02962

§ 371 Date: Aug. 2, 2010

(30) Foreign Application Priority Data
Sep. 1, 2007 (GB) 0717019.4

(51) Int. Cl. H04N 7/14

(52) U.S. Cl. 348/14.02; 348/14.1; 348/14.03; 348/E07.078

(57) ABSTRACT

An audiovisual terminal for use in videoconferencing or in providing online services is provided with a high resolution camera for capturing a video image of the operator. The camera is mounted at a distance from the operator and has a narrow field of view allowing a significantly clearer image of the operator to be obtained than is normally possible with a conventional webcam. The operator is also provided with a headset incorporating a microphone and a loudspeaker. The operator is provided with a primary display unit, displaying control information for operating the terminal and may also display visual or other date received from external sources. A secondary display is operable to display the video image captured by the camera. This allows the operator to monitor the operation of the camera during a videoconference call.

The present invention relates to an audiovisual terminal, and in particular to an audiovisual terminal that is suitable for use in online video conferencing and for use by customer support agents or sales agents.

It is now relatively common to provide online customer support or sales advice, for instance by way of a phone or text conversation between a company's agent and a customer or potential customer. Whilst this does provide some measure of interactivity, an increased level of interactivity is desirable, particularly given the proliferation of high speed Internet connections. One possibility is to provide a real-time webcam video image of the agent. This however has the drawback that images provided by webcams are typically poor due to the provision of wide angle lenses and low pixel counts/update rates. Even with good webcam images, it can be difficult to provide any additional useful information.

Another common practice in the present day is videoconferencing. Such video conferences require all parties to be connected via a high speed network and to be provided with a camera and microphone for recording their contribution, a screen and loudspeaker for broadcasting the other parties' contributions. Whilst this does provide an alternative to meeting in person, there are a number of common drawbacks. For instance, it is difficult for parties to convey new information to one another, such as ideas developing in the conference. By contrast, in a face to face meeting, parties can draw diagrams explaining new ideas which may be passed around. Another difficulty is that typically, persons will need a special room or area that is provided with the necessary equipment for video conferencing. This limits the easy availability of conferencing as users must be sure that the equipment is available. Additionally, it creates an inconvenience for the user of requiring that they convey all relevant materials and/or files to the special room in advance of the video conference.

It is therefore an object of the present invention to provide a new audiovisual terminal that provides for improved video conferencing and/or online support operations.

According to a first aspect of the present invention there is provided an audiovisual terminal comprising: audio and visual recording means for making an audiovisual recording of an operator; audio and visual output means for outputting audiovisual data; control means for operating the terminal; connection means for facilitating the receipt and transmission of audiovisual data; and a backdrop panel provided behind the operator with respect to the visual recording means.

This set up provides a terminal wherein an operator can readily take part in videoconferencing or in audiovisual online sales or support applications. Additionally or alternatively, the terminal may be used for the generation, transmission, receipt or viewing of v-mail (video mail). Furthermore, the terminal can be utilised as a normal working area, when video conferencing is not required.

The terminal may be adapted such that the visual recording means is a video camera with a narrow field of view, which may be a high resolution camera. The visual recording means is preferably positioned at a sufficient distance from the operator that it is able to capture a clear image of at least the operators head. The position of the visual recording means and the field of view may be adapted such that the image of the operators head takes up a desired proportion of the area of the captured image, say around 50% of the image area. Another suitable proportion, for example, would be the area of an image taken up by a newsreader in contemporary television news broadcasts. By using a camera with a narrower field of view than the traditional webcam and positioning that camera further from the user than the traditional webcam, a clear image of the operator can be obtained without the distortion resulting from the use of wide angle lenses in conventional webcams. By positioning a camera with a narrow field of view at a distance from the operator, the captured image provides a less distorted image of at least the operators head as compared with a conventional webcam. An additional benefit of this arrangement is that there is less background information in view which can be both unsightly and distracting to a viewer.

The backdrop panel screens movement behind the operator from capture by the visual recording means. The backdrop panel may be adapted to provide a contrast to the operator so as to improve the clarity of the captured image. The backdrop panel may be adapted to display data. The data may comprise a still image or a moving image. The data displayed may be controlled by the operator. The data controlled by the operator may consist of any type of data. In particular, this may include stored still or moving image files including such text, diagrams, screenshots and/or promotional imagery as appropriate. Additionally or alternatively, the operator may be able to create new still or moving image data in real time and/or create and store still or moving image data for future use. Any such still or moving image data may have associated audio data. Such audio data may be created at the same time as the image data or added to the image data. In particular, two or more layers of audio data can be provided. This would allow an operator to provide a live voice over on a pre-recorded still or moving image. The backdrop panel may be supported between a pair of upstanding legs.

Data display on the backdrop panel may be achieved by projection onto the panel from a projector means or by incorporating a display unit into the panel. A suitable display unit may be an LCD, LED display, plasma screen display or similar.

The control means may comprise control input means and a processor means. The control input means may comprise a keypad and/or a pointer device. The keypad may be of the same form as a conventional computer keyboard. The pointer device may be a computer mouse, trackball, joystick, touch sensitive pad or similar. If suitable, the pointer device may be incorporated into the keyboard. The processor means may be a personal computer. If required or appropriate other suitable control and/or input means may be provided including scanning means and or means operable by an operator to generate freehand drawings such as a graphic tablet or similar.

The audio and visual output means may include a data display unit provided in front of the operator. The data display unit may be an LCD, LED display, plasma screen display or similar. The audio and visual output means may also include one or more loudspeakers. The loudspeakers may be integrated into the display unit or may be separate units. Additionally or alternatively, the loudspeakers may be mounted on, in or to any other component of the terminal. The loudspeakers may be fixed in position or may be moveable by way of translation and/or rotation. As a further alternative, the loudspeakers may be mountable on or in the vicinity of the operator.

The data display unit may be operable to display incoming audiovisual data. The data display unit may be free standing or may be mounted on in or to any other component of the terminal. The data display unit may be fixed in position or may be moveable by way of translation and/or rotation. The data display unit may be additionally or alternatively operable to display terminal control information or the image captured by the visual recording means in addition to or in place of incoming or outgoing data. In some embodiments, two or more display units may be provided. In such cases, said display units may be dedicated for the display of incoming or outgoing audiovisual data, control information, the image captured by the visual recording means or any other suitable data. If two or more display units are provided, they need not be positioned adjacent to one another, for example a primary display unit may be provided directly in front of the operator and one or more secondary display units may be provided at other locations, such as adjacent to the visual recording means. Each said display unit may be of the same type or may be of a different type. Each display unit may be of the same size or of a different size. The sizes of each display unit may be selected to be suitable for purpose.

The audio recording means may comprise a microphone mountable on or in the vicinity of the operator. The microphone may be connected to the terminal by a wired or via a wireless link. The microphone and the loudspeakers of the audio and visual display means may be integrated into a headset.

The terminal may be provided with additional audio/visual recording means. This may be in the form of connections to cameras and/or microphones at locations remote from the terminal. Such connections may be wired or wireless connections, as desired or as appropriate. Additionally or alternatively, the audio/visual recording means may be in the form of a dedicated unit comprising a camera and/or a microphone which may be carried by an operator from the terminal to a remote location. The dedicated unit may comprise control means for controlling the operation of the control unit and/or the terminal. The dedicated unit may be connected to the terminal by means of a suitable wired or wireless connection, as desired or as appropriate. Other forms of suitable dedicated remote units may also be provided.

In one embodiment, the terminal may be provided with a fine detail visual recording means such as a camera, operable to capture a high resolution, narrow field image at a short focal length. Such a fine detail visual recording means can be thus used to provide images of fine detail on an object or images of the whole of a small object. In order that the fine detail visual recording means can be manipulated into an appropriate position it may be provided upon suitable operator adjustable mounting means such as a spring balanced articulated arm or similar. The fine detail visual recording means may be pivotally mounted at the end of such an arm. Additionally or alternatively, the arm may further be pivotally mounted about a base.

The connection means may comprise wired or wireless connections to a data network. The data network may be local private network. Additionally or alternatively, the connection means may facilitate connection to a public network such as the internet, television or telephone network. The received data may comprise audiovisual data or may comprise other forms of data, including but not limited to purely audio data, purely visual data, text data or similar.

The terminal may be provided with lighting means to help the camera obtain a clear image of the operator. The lighting means may comprise front lighting means positioned in front of the operator for the illumination of the operator. The front lighting means may be soft lighting means. In this context soft lighting refers to lighting capable of illuminating an object such that shadows cast have ill-defined edges. Rear lighting means may additionally be provided. The rear lighting means may be operable to illuminate the backdrop panel and or the operator. Illumination from behind can improve the captured image of the operator.

The terminal may be provided with one or more warning indicators. The warning indicators are operable to output a visual indication as to whether the terminal is currently in operation. The warning indicators may take the form of one or more lights operable to output light of a first colour when the terminal is in recording operation and light of a second colour when the terminal is not in recording operation. In one preferred embodiment, the first colour may be red and the second colour may be green. In some embodiments the lights may be additionally or alternatively adapted to illuminate lettering. In such an embodiment the lights may illuminate lettering in the form ‘ON AIR’ or similar when the terminal is in recording operation and lettering in the form ‘OFF AIR’ or similar when the terminal is not in recording operation. The lights may comprise appropriately filtered incandescent bulbs, halogen bulbs, florescent tubes or similar. Alternatively, the lights may comprise suitable LCD or LED arrays. In an alternative embodiment, it is of course possible for the indicator light only to be operated when the terminal is in operation and for no indicator to be operated when the terminal is not in operation.

The terminal may be provided in the form of a desk unit. The working surface of the desk unit may have two or more arms. One arm may be provided in front of the operator and may support the primary display unit and the control means. A second arm may stretch away in front of the user and may at its distal end support anyone or all of a secondary display means, front lighting means, the video camera as desired or as appropriate. The desk unit may incorporate one or more screening panels, in front of and/or to the side of the operator. The desk and said panels may be connected and supported by upstanding legs. In embodiments with a side panel, the side panel may share an upstanding leg with the backdrop panel. In some embodiments, the processor means and/or the connection means may be provided within one or more of the upstanding legs.

According to a second aspect of the present invention there is provided a method of capturing a video image of a participant in a video conference comprising capturing the image using a video camera having a narrow field of view positioned at sufficient distance from the participant that the head of the participant fills around half of the captured image.

According to a third aspect of the present invention there is provided a method of capturing a video image of a participant in a video conference comprising capturing the image using a video camera characterised in that a display screen is provided behind the participant within the field of view of the video camera such that additional information displayed on the display screen may form part of the captured image.

According to a fourth aspect of the present invention there is provided a method of connecting a video conference between two terminals in accordance with the first aspect of the present invention comprising the steps of: providing an online directory of terminal operators; enabling terminal operators to connect to said online directory; enabling connected terminal operators to select other terminal operators from the online directory; and enabling audiovisual data to be routed between said connected terminal operator and said selected terminal operator.

The online directory may comprise a list of names and/or images identifying the terminal operators. The names may be real names, company names or usernames. The directory may be searchable. An operator may set permissions with regard to which other operators may view their entry in the database and/or which operators may send audiovisual data to them.

The methods of the second, third and fourth aspects of the present invention may incorporate any or all of the features described in respect of the first aspect of the present invention as is required, desired or appropriate.

In order that the invention can be more clearly understood it is now described further below with reference to the accompanying drawings:

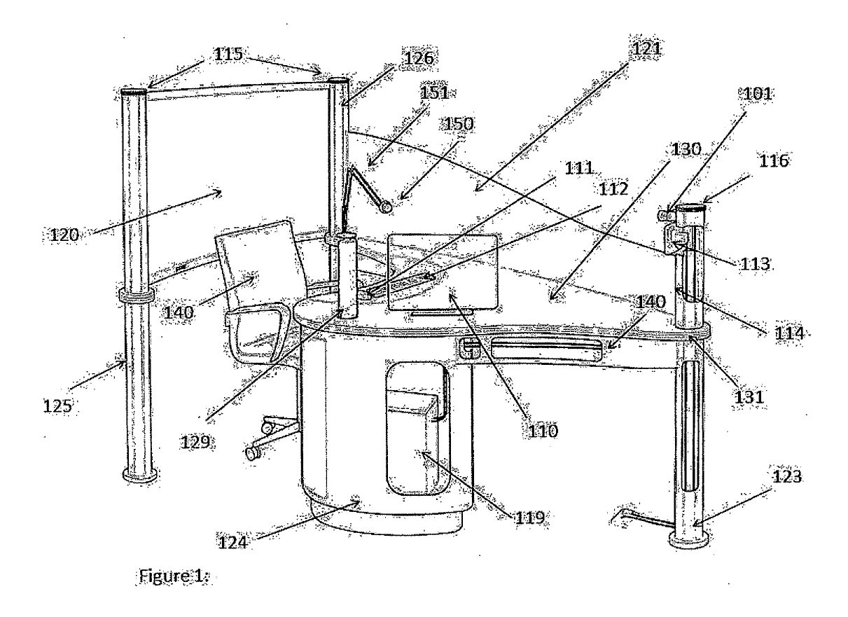

FIG. 1 is a schematic view of an audiovisual terminal according to the first aspect of the present invention;

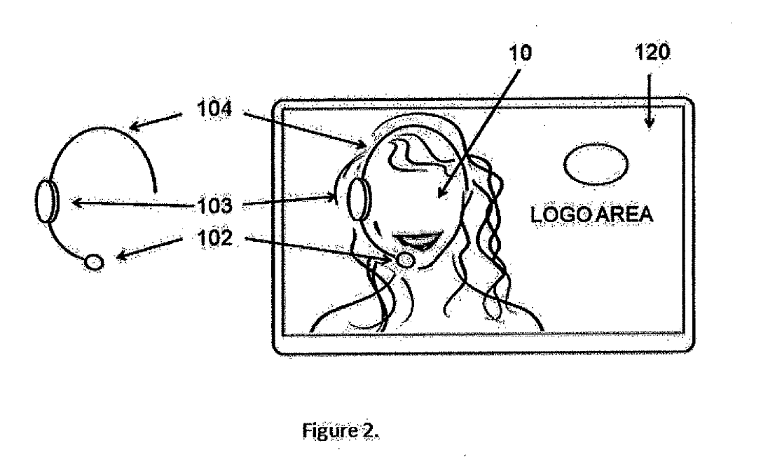

FIG. 2 is an indication of a typical image captured by the visual recording means of the audiovisual terminal of FIG. 1;

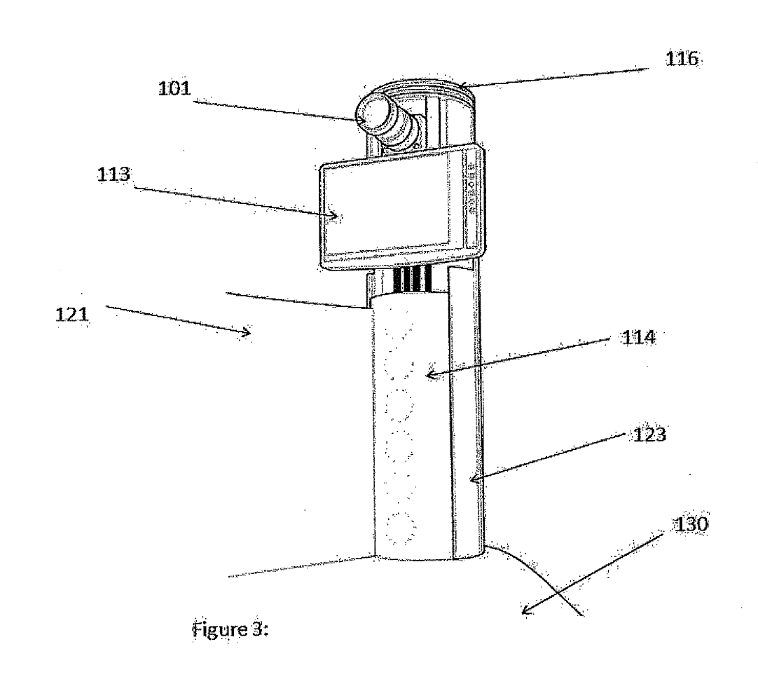

FIG. 3 is a more detailed view of the front portion of said audiovisual terminal incorporating said visual recording means; and

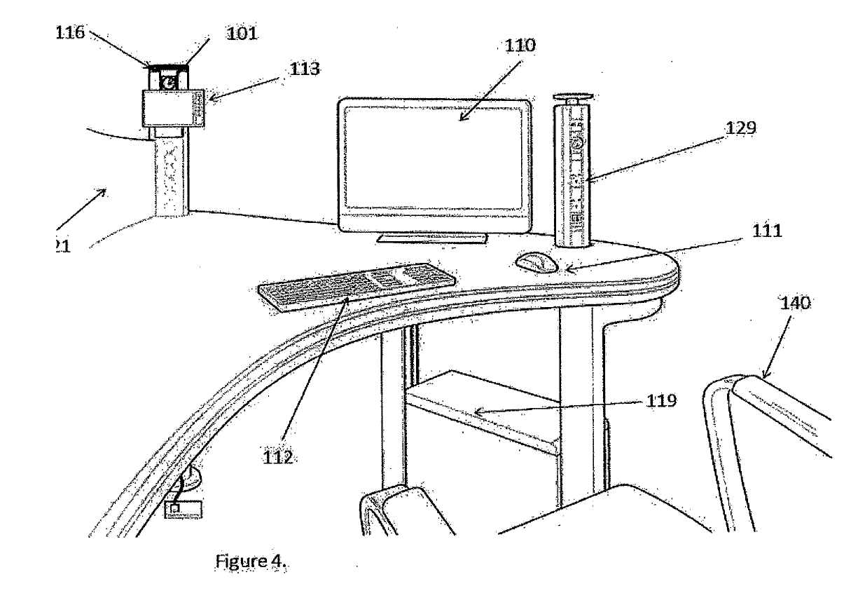

FIG. 4 is an operator's view of said audiovisual terminal.

Referring now to FIG. 1, an audiovisual terminal 100 according to the present invention is shown. The terminal 100 is incorporated into a desk thereby providing convenience and comfort for operator 10 whilst they are engaged in videoconferencing or in providing online services.

In order that the terminal 100 can operate as desired it is provided with a high resolution camera 101 for capturing a video image of the operator 10. The camera 101 is mounted at a distance from the operator 10 and has a narrow field of view, such that operator's head takes up around half of the captured image. Of course it is possible for the this proportion to be varied when required but typically the proportion would not be expected to drop below 25% or rise above 75% of the captured image area. Using a high definition camera 101 with a narrow field of view and mounting said camera 101 at a sufficient distance allows a significantly clearer image of the operator 10 to be obtained than is normally possible with a conventional webcam. An example of such a captured image is shown in FIG. 2. One suitable camera for implementing the invention would be a digital camera fitted with a varifocal lens (3-8 mm) F1.4 operable at 25 frames per second.

As is shown in FIG. 2, the operator 10 is also provided with a headset 104 incorporating a microphone 102 and a loudspeaker 103. This enables the operator's voice to be recorded and enables the operator to hear audio data received from external sources. The headset 104 may be connected to other components via a wire or via a wireless link as desired. Alternatively, if so desired, the operator 10 may be provided with separate microphone and earpiece loudspeaker.

The operator 10 is provided with a primary display unit 110, here comprising a 20 inch LCD display. The primary display 110 displays control information for operating the terminal and may also display visual or other data received from external sources. The operator is also provided with a keyboard 112 and mouse 111 by means of which they can control the terminal 100. The display, keyboard and mouse 110, 111, 112 are here resting on a desktop panel 130. In alternative embodiments, the keyboard 112 may incorporate a suitable pointing device such as a trackball, joystick or touch sensitive pad in place of mouse 111.

A secondary display 113 is also provided. The secondary display 113 is operable to display the video image captured by the camera 101. This allows the operator 10 to monitor the operation of the camera 101. Additionally or alternatively, the secondary display 113 can be operable to display the audiovisual information transmitted by the terminal 100. As a further alternative, the secondary display 113 can display information received by the terminal 100 and/or any other suitable data including text. In some embodiments a suitable control interface may be provided enabling the operator 10 to toggle between different display modes displaying different data

Front lighting means 114, 116 may be provided alongside the secondary display 113. The front lighting means 114 are operable to provide soft lighting of the operator 10 for camera 101. The front lighting means 114 may include pop up lights incorporated into other components of the terminal 100. The front lighting means 114 may also provide an element of side lighting, if required or desired. The front lighting means 116, by contrast may act as an in operation or ‘on air’ warning to persons in the vicinity of terminal 100.

Behind the operator 10 is also provided a fine detail camera 150, operable to capture a high resolution, narrow field image at a short focal length. It can be thus used to provide images of fine detail on an object or images of the whole of a small object. In order that the fine detail camera 150 can be manipulated into an appropriate position it is provided upon a spring balanced articulated arm 151 (of course an alternative form of operator adjustable mounting may be utilised in alternative embodiments). The camera 150 may be pivotally mounted at the end of the arm 151 and the arm may further be pivotally mounted about a base fixed to desk panel 130.

Behind the operator 10 are also provided rear lighting means 115 to further improve the lighting of the operator 10 and/or to act as an in operation or ‘on air’ warning to persons in the vicinity of terminal 100. In the figure the rear lighting means 115 are in the form of translucent/transparent caps upon upstanding support legs 125, 126. In alternative embodiments however other forms of rear lighting means 115 can be additionally or alternatively provided. This may include upwardly and/or downwardly directed lamps.

Behind the operator is provided a backdrop panel 120. The backdrop panel 120 provides a backdrop to the captured image of the operator 10 and additionally is operable to display images behind the operator 10. The images displayed can be controlled by the operator 10. The images may be displayed by projection from a suitable projection means (not shown) or by providing a display unit (such as an LCD, LED, OLED or similar display unit) within the panel 120.

The backdrop panel 120 is provided between a pair of upstanding support legs 125 and 126. Leg 126 in combination with leg 123 and a larger leg unit 124 provides support for the desktop panel 130. Between leg 126 and leg 123 is provided an optional side courtesy panel 121 screening the operator from adjacent desks etc. Between leg 123 and large leg 124 is provided an optional front modesty panel (not shown). The panels 120, 121 may be formed of any suitable material.

There is also provided a pop up (or optionally permanently upstanding) post 129. The post 129, as is shown in FIG. 4 may comprise one or more sockets for facilitating data or power connections between the terminal and additional devices. The data sockets may comprise USB, Firewire, serial or other similar sockets. The post 129 may additionally or alternatively incorporate one or more media drives, for instance CD or DVD drives.

A processing unit, which may be an appropriate programmed or otherwise adapted personal computer 119, is provided within the large leg unit 124 to run the operation of the terminal 100. In use, for video conferencing, the operator 10 sits on seat 140 in front of the desk panel 130. The video camera 101 captures a video image of the operator 10 and the microphone 102 records the operator's speech. The video camera 101 will also capture some data displayed on the backdrop panel 120 behind the operator 10. The recorded audio visual data is transmitted via any suitable link to the other participant(s) in the video conference. Simultaneously, the terminal 100 will receive audio visual data from the other participant(s) and display it to the operator 10 on primary display unit 110 or secondary display unit 113. Advantageously, if the operator views images on secondary display unit 113, on the image captured by camera 101 the operator 10 will appear to be looking directly towards the camera 101. This arrangement thus facilitates a naturalistic video conferencing pose on behalf of the operator.

During the conference, the operator 10 can control the display of images on the backdrop panel 120. typically, these may be images to improve the ease of viewing the operator, transmit a desired tone (e.g. a view of a beach when discussing holidays) or perhaps convey branding information such as the display of a company or sponsor logo. This additionally or alternatively allows the operator 10 to communicate additional information to the other participant(s). The additional information may comprise stored data or data generated by the operator 10 during the conference. Stored files might typically include company logos or information, visual demonstrations of the operation of articles or systems or visual records of people and/or places such as still or moving images. Operator generated content may comprise diagrams or similar drawn by the operator during the conference. Suitable additional means for the preparation and/or digitisation of such diagrams may be provided. Additionally or alternatively, the operator 10 may be able to transmit the visual data displayed on the backdrop panel 120 directly to the other participant(s).

In an alternative use of the terminal 100, the operator may be providing online information or support to a customer. In such circumstances, the customer may not have access to equipment for sending audiovisual data to the terminal 100. In such circumstances, the terminal 100 might receive only text data from the customer but would still be operable to transmit audio visual data to the customer. For instance, the customer may log on to a company website using their home computer. The home computer is equipped only to transmit text information and/or simple attachments but is able to receive audiovisual data from the terminal. The customer can thus view the operator 10 on the screen of their home computer. Of course, if the customer has suitable equipment, they would be able to transmit audio and/or visual information to the operator 10, if desired.

As the operator 10 is displayed to the customer, the customer may be able to follow the operator's help instructions, teaching/training information or sales advice more clearly. The backdrop panel 120 in such circumstances may be used to display any stored or streamed file content including instructional diagrams or screenshots, promotional imagery or other suitable imagery. As in the video conferencing application, the operator may be able to directly transmit the images displayed on the backdrop panel 120 to the website window.

A further alternative embodiment of the terminal 100 might omit either or both of the panels 121, 122. This would allow the terminal to be provided in an office, shopfloor or showroom type environment. This would thereby allow and operator 10 to interact directly with customers or users who pass the terminal 100, in addition to being able to interact with remotely based customers or users. In such embodiments, the display 110 may be mounted such that it can be translated or rotated such that data displayed thereon can be seen by the local customers or users.

A still further implementation would allow the automated connection of conference calls made using terminals 100. In such an implementation an online directory of terminal operators may be provided. Operators may register for the directory and their entry may comprise their name, their company name, their user name or an image of them as appropriate. Operators may then select another operator to contact using the directory at which point an audiovisual data connection is opened between the respective operator terminals via the server hosting the online directory. in order to ensure privacy and to prevent prank or abusive calls, operators may set suitable privacy settings when registering, thus enabling them to restrict whom can view their directory entry and/or connect a video conference call to them.

It is of course to be understood that the invention is not to be restricted to the details of the above embodiments which have been described by way of example only.

1-39. (canceled)

40. An audiovisual terminal comprising: audio and visual recording means for making an audiovisual recording of an operator; audio and visual output means for outputting audiovisual data; control means for operating the terminal; connection means for facilitating the receipt and transmission of audiovisual data; and a backdrop panel provided behind the operator with respect to the visual recording means, wherein the visual recording means is a high resolution video camera with a narrow field of view.

41. An audiovisual terminal as claimed in claim 40, wherein the visual recording means is positioned at a sufficient distance from the operator that it is able to capture a clear image of at least the operators head and wherein the position of the visual recording means and the field of view are adapted such that the image of the operators head takes up a desired proportion of the area of the captured image.

42. An audiovisual terminal as claim 40, wherein the backdrop panel is adapted to provide a contrast to the operator so as to improve the clarity of the captured image.

43. An audiovisual terminal as claimed in claim 42, wherein the backdrop panel is adapted to display data, which may or may not be controlled by the operator and wherein said data display on the backdrop panel is achieved by: projection onto the panel from a projector means; or by incorporating a display unit into the panel.

44. An audiovisual terminal as claimed in claim 40, wherein: the control means comprises control input means being a keypad and/or a pointer device such as a computer mouse, trackball, joystick or touch sensitive pad; and a processor means such as a personal computer.

45. An audiovisual terminal as claimed in claim 40, wherein the audio and visual output means include a data display unit provided in front of the operator which is free standing or is mounted on, in or to any other component of the terminal and wherein the data display unit is fixed in position or is moveable by way of translation and/or rotation.

46. An audiovisual terminal as claimed in claim 40, wherein the audio and visual output means include one or more loudspeakers, which are integrated into the display unit or are separate units mounted on, in or to any other component of the terminal or mountable on or in the vicinity of the operator and wherein the loudspeakers are fixed in position or are moveable by way of translation and/or rotation.

47. An audiovisual terminal as claimed in claim 45, wherein the data display unit is operable to display incoming audiovisual data and/or terminal control information and/or the image captured by the visual recording means.

48. An audiovisual terminal as claimed in claim 45, wherein two or more display units are provided and wherein said display units are dedicated for the display of incoming or outgoing audiovisual data, control information, the image captured by the visual recording means or any other suitable data.

49. An audiovisual terminal as claimed in claim 48, wherein a primary display unit is provided directly in front of the operator and a secondary display unit is provided adjacent to the visual recording means.

50. An audiovisual terminal as claimed in claim 40, wherein the audio recording means comprises a microphone mountable on or in the vicinity of the operator and connected to the terminal by a wired or via a wireless link.

51. An audiovisual terminal as claimed in claim 40, wherein the terminal is provided with additional audio/visual recording means.

52. An audiovisual terminal as claimed in claim 40, wherein the terminal is provided with a fine detail camera, which is either fixed or moveable and which is operable to capture a high resolution, narrow field image at a short focal length.

53. An audiovisual terminal as claimed in claim 40, wherein the connection means comprises wired or wireless connections to a local private network or a public network such as the internet, television or telephone network.

54. An audiovisual terminal as claimed in claim 40, wherein the received data comprises audiovisual data and/or purely audio data, purely visual data or text data.

55. An audiovisual terminal as claimed in claim 40, wherein the terminal is provided with lighting means comprising: soft front lighting means positioned in front of the operator; and/or rear lighting means operable to illuminate the backdrop panel and/or the operator.

56. An audiovisual terminal as claimed in claim 40, wherein the terminal is provided with one or more warning indicators operable to output a visual indication as to whether the terminal is currently in operation.

57. An audiovisual terminal as claimed in claim 40, wherein the terminal is provided in the form of a desk unit which incorporates one or more screening panels, in front of and/or to the side of the operator and wherein the desk and said panels are connected and supported by upstanding legs.

58. A method of capturing a video image of a participant in a video conference comprising capturing the image using a video camera having a narrow field of view positioned at sufficient distance from the participant that the head of the participant fills around half of the captured image wherein a display screen is provided behind the participant within the field of view of the video camera such that additional information displayed on the display screen may form part of the captured image.

59. A method of connecting a video conference between two audiovisual terminals, wherein each audiovisual terminal comprises: audio and visual recording means for making an audiovisual recording of an operator; audio and visual output means for outputting audiovisual data; control means for operating the terminal; connection means for facilitating the receipt and transmission of audiovisual data; and a backdrop panel provided behind the operator with respect to the visual recording means, and wherein the visual recording means is a high resolution video camera with a narrow field of view, the method comprising the steps of: providing an online directory of terminal operators; enabling terminal operators to connect to said online directory; enabling connected terminal operators to select other terminal operators from the online directory; and enabling audiovisual data to be routed between said connected terminal operator and said selected terminal operator.

60. The method of claim 59, wherein the online directory comprises a list of names and/or images identifying the terminal operators and wherein an operator sets permissions with regard to which other operators may view their entry in the database and/or which operators may send audiovisual data to them.
